(19) United States
(12) Patent Application Publication
(10) Pub. No.: US 2013/0006827 A1
(43) Pub. Date: Jan. 3, 2013

(54) GROUP BASED TRADING METHODS

(75) Inventor: Sander KAUS, Tallinn (EE)

(73) Assignee: WALDSTOCK LTD, Tallinn (EE)

(21) Appl. No.: 13/534,688

(22) Filed: Jun. 27, 2012

Related U.S. Application Data
(60) Provisional application No. 61/502,664, filed on Jun. 29, 2011.

(51) Int. Cl. G06Q 40/04

(52) U.S. Cl. 705/37

(57) ABSTRACT

The disclosure relates generally to methods of determining whether to engage in an open market based trade. More specifically, the disclosure relates to methods of formulating a consensus on whether to engage in an open market based trade, itself based on prior trade history of each trader and a ranking of each trader based on the trader's previous prediction in whether a trade will result in monetary gain.

### CROSS-REFERENCES TO RELATED APPLICATIONS

This application claims benefit under 35 U.S.C. §119(e) to U.S. Provisional Application Ser. No. 61/502,664 filed on Jun. 29, 2011, and titled Group Based Trading Methods, which is hereby incorporated by reference in its entirety.

### FIELD

The disclosure relates generally to methods of determining whether to engage in an open market based trade. More specifically, the disclosure relates to methods of formulating a consensus on whether to engage in an open market based trade, itself based on the opinions of community members (traders), prior trade history of each trader and a ranking of each trader based on the trader's previous success in predicting whether a trade will result in monetary gain.

### BACKGROUND

The foreign exchange market, (“FX”) enables currencies to be exchanged in order to do business internationally. FX is the largest financial market in the world with a trading volume about $4 trillion a day (BIS report 2010), which is ten to fifteen times the size of the daily trading volume on all stock markets combined. FX transactions are broken down into spot transactions and three derivative instruments (forwards, swaps and options). Spot trading is the purchase or sale of a foreign currency or commodity for immediate delivery (FRNBY 2010). FX Spot transactions hold a 37.4% share from all FX transactions and contributed 48% from the recent 21% growth of the FX market trading volume during 2007-2010 (BIS report 2010).

A large part of the growth in FX trading is derived from the FX retail trading market, which is rapidly growing segment of the FX spot market. According to the last analysis by the Aite Group (2010) the average retail FX trading daily volume has grown from of approximately $10 billion in 2001 to $158 billion in 2010, representing a CAGR of 37% and 4% of total FX trading volume.

There is a strong belief within large market players that FX retail trading will have large growth potential as overall awareness of FX continues to grow and FX continues to play central role in the global economy (FXCM 2010, Gain Capital 2009).

One of the reasons for the emergence of the retail FX growth in the last decade is that the FX spot market has turned to an asset class which is more rational to trade for many online investors as in some currency pairs it may not correlate to other asset classes like equities, commodities and securities. Additionally, the trading in the FX market can be conveniently accomplished at any time of day. The FX market also has the important characteristic of liquidity, which investors desire in an organized financial market.

FX trading also has an advantage over equity markets by having a borderless marketplace. It is estimated that 65% of the transactions are made cross border (BIS 2010). A borderless marketplace allows traders to negotiate directly with one another, without central control from a clearing house. FX trading is therefore simple, homogenous and with few regulatory hurdles for traders.

Still another reason for the emergence of the retail FX growth is its speculative nature. It is believed that 70-95% of the trading is speculative. Speculation derives from volatility. The latter roots from changes in the market, especially from good and/or bad news. Recent turbulence in financial markets and economic downturn has fuelled liquidity to it. Therefore the FX market does not usually correlate to other asset classes.

Despite the strong recent growth, online retail FX investors still represent a small fraction of the total population of online investors. Aite Group (2010) estimated that in 2010 there were over 110 million retail online investors (equities, commodities, FX, etc.) globally, but only 1.1 million FX retail investors. Consequently retail traders/investors constitute a growing segment of this market.

The Bank of International Settlements gathers reports about FX market transactions from 1320 reporting participants who globally provide FX trading services (BIS 2010). Larger FX retail service providers are FXCM (150000 trading customers), Gain Capital (55000 trading customers) etc.

Retail customers of FX are usually served around the world from similar technological infrastructures. These systems have so far been the collection of indicators and chart patterns that one can examine to determine when to enter or exit a particular currency pair market. According to recent survey among 80 traders 85% claim that they receive only 0-40% trading decision information from their current trading platforms (research was conducted by Floyd, Gordon & Partners among Aspen Trading Group (ATG) customers, who get regular market research from ATG). Trading platforms simply provide streaming market information without additional value for trading decisions. Therefore traders source and conduct their own analysis to execute trades.

### SUMMARY

Certain embodiments of the disclosure pertain to a method of generating a value for determining whether to engage in a transaction, the method comprising: a) establishing a network of traders; b) assigning a trade success value to each trader based, for example, on each trader's previous success in predicting a change in value in one or more transaction; c) determining an opinion for each trader on whether engaging in a transaction would result in financial gain or loss, wherein each opinion is a weighted opinion based on the trade success value of the trader; and d) combining each weighted opinion to generate a value; wherein a value indicates approval or disapproval of engaging in a transaction.

In further embodiments, the value is a numerical value or an expression derived from numerical value (e.g. thermometer, color pallet etc.). In such embodiments, the value can be expressed as a percentage or fraction of the sum of all weighted opinions. In embodiments wherein the value is expressed as a percentage or fraction of a sum of all weighted opinions, a certain percentage or fraction may indicate that the transaction would be favorable. There may be any threshold. For example, when expressed as a percentage the threshold may be 1%, 10%, 20%, 30%, 40%, 50%, 60%, 70%, 80%, 90% or 100% or some threshold within this range. In certain embodiments, wherein the threshold is above a certain fraction or a percentage, such as ½ or 50%, the value is considered favorable or not favorable for initiating a transaction. In such embodiments, one or more subscriber, one or more trader or one or more administrator of the network may engage or disengage in the transaction. In certain embodiments, wherein a value is favorable, the transaction may be initiated automatically. In such embodiments, the option of automatic initiation of the trade may be made before collecting opinions, at the time of collecting opinions or after each desired opinion is collected. If the value from the weighted opinions is negative (not favorable to the proposed transaction) a reverse (contradictory) transaction may be initiated (instead of going long, as proposed, the value may indicate to go short, which will then be transacted accordingly).

In certain embodiments the traders may have a bank account or credit line operatively linked to the network. In other embodiments, the network itself may be operatively linked to one or more bank accounts or lines of credit. In certain embodiments, the network may engage in the favorable transaction on behalf of the traders.

In the embodiments of the disclosure, wherein a transaction is contemplated, the transaction may be any transaction. In specific embodiments the transaction (going long or short) is a stock purchase, bond purchase, mutual fund purchase, foreign monetary exchange or other transaction, which may take place in an open market.

In certain embodiments wherein voting is contemplated, the voting may be anonymous, for example to avoid a herd following behavior. In other embodiments, the results may be hidden from the voters until after a vote by an individual voter, until after a certain percentage of voters have voted, or until after all voters have voted. The outcome of the voting may be disclosed for a charge or free of charge.

In embodiments of the disclosure wherein a network of traders is contemplated the traders may be subscribers to the network. In specific embodiments, the network may be a computer network.

In further embodiments of the disclosure wherein a transaction is contemplated, a proposal for a transaction to traders, such as traders on the network may first be initiated. Such a proposal may come from a trader, an administrator of the network or a combination thereof. In instances wherein a proposal is contemplated, the proposal may be communicated to traders via social networking, podcasting, instant messaging, GUI pop-up, telephone, email, text message, facsimile, mail, a website and the like or a combination thereof.

### BRIEF DESCRIPTION OF THE DRAWINGS

FIG. 1 is a graph illustrating the trade success rate required to profit in various leverage and spread scenarios;

FIG. 2 is a diagram illustrating a feedback weighting system based on user rankings;

FIG. 3 is a flow chart illustrating parallel steps in the methods for determining whether to engage in a transaction, from the perspective of the network operator and of a trader;

FIG. 4 is a block diagram illustrating the layout of a system for determining whether to engage in a transaction;

FIG. 5 is a block diagram illustrating the layout of a computer system for implementing the method for determining whether to engage in a transaction;

FIGS. 6, 7 and 8 are diagrams of illustrating attention concentration by trade alert;

FIG. 9 is a table illustrating weighting of opinions based on past performance;

FIGS. 10 and 11 illustrate how each trade and/or opinion is periodically compared with actual market movements automatically by the system in order to find out the performance of the action;

FIG. 12 illustrates one trader's actions and how the system may derive performance measures for the trader's opinion performance weighting and his/her overall ranking.

### DETAILED DESCRIPTION

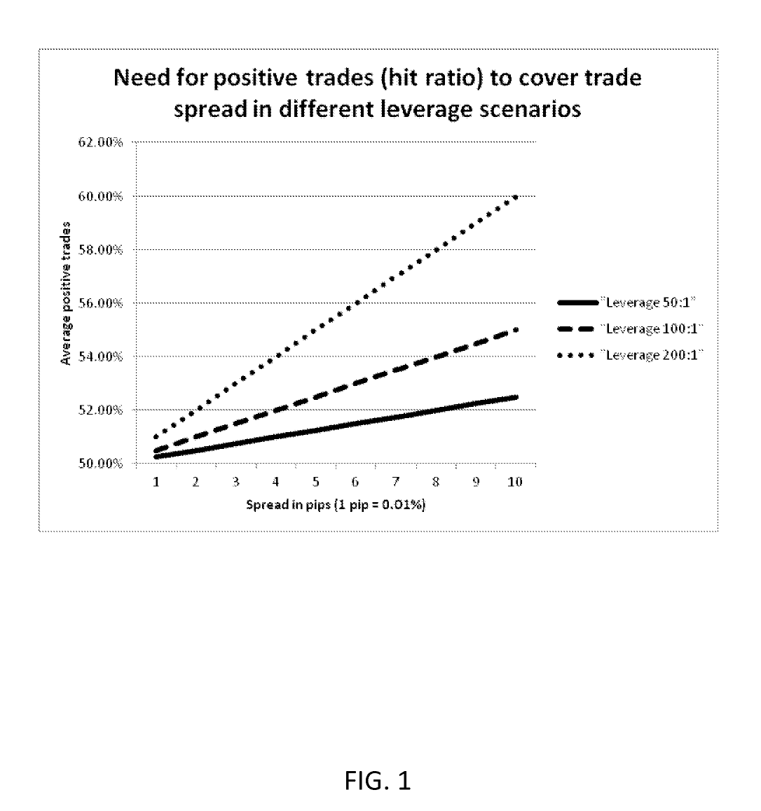

The embodiments of this disclosure pertain to improvements in the manner by which participants engage in the trading of different markets (e.g., the FX market). For traders, trading profitability is crucial, but in long term it is very hard to achieve, especially in high leverage scenarios. FIG. 1 illustrates the percentage of positive trades (hit ratio) required to cover common bid/ask spreads for various leverage scenarios. With a spread of 5 pips (a pip is the smallest possible change in a currency pair, typically 0.01%), a high leverage (200:1) trader must trade equal trades correctly almost 55% of the time in order to break even. Only a fraction of traders are able to trade consistently well.

Currently FX trading is typically an individual business. Successful trades are based on having a good memory of winning trading patterns. Traders collect and interpret market information, source for supportive information from technical and/or market analysis and/or research individually and execute trades based on their experience of winning patterns. However, it is estimated that while 80% of traders do not share their outcome of the analysis and/or their trading ideas, most traders would still seek additional opinions for their trading ideas/findings.

The overwhelming amount of information contributes to the speculative nature of the FX market. The relative/speculative movements of currencies originate from zero-sum logic and the large amount of variables to be analysed. Winners are those who can interpret them quicker and more accurately. However one person is not able to follow and interpret all incoming information. Even with the aid of computer systems, which are able to quickly track movements online, it is difficult to predict the next move in a currency pair because all of the factors affecting the next move are not knowable. This is why any personal evaluation or stand alone system has inherent limits on accuracy and is vulnerable to the “butterfly effect,” where leaving out any one condition can affect the result.

The FX market is zero-sum profit market. Zero-sum describes a situation in which a participant's gain (or loss) is exactly balanced by the losses (or gains) of the other participant(s) and by adding up the total gains and losses of the participants they will sum to zero (Investor Dictionary). This means that every win is somebody's loss and in theory trading winning/losing probabilities should be 50/50. The non-correlative nature to other markets and zero-sum logic in the FX market fuel its speculative nature. Global and local market events generate currency market speculations. These currency market speculations in turn generate a higher turnover in trades within the FX market.

In many instances, the FX market moves towards the speculative belief of traders (herd). These herd behavioral movements are hard to track/predict and therefore although currency movements in many ways relate to market events, without extensive prior trading experience and diligent analysis, FX trading may very quickly become gambling-like activity.

In the various embodiments of the invention, trading profitability can be improved by pooling the information and expertise of a network of traders, and harnessing that information and expertise to predict the movement of markets and identify favorable transactions. The “crowd behavior” of the network of traders becomes statistically significant when the network has 35 or more active members. In general, the more traders in the network, the more information will be available, and the better the predictions will be. However, when the size of the network reaches a certain threshold, the traders in the network will distort the market and the pooled information will become ineffective. To ensure continued effectiveness, the network of traders should not exceed 10% of the total trading crowd (for example, in the FX market, this would be currently approximately 180,000 traders).

The effectiveness of predictions can also be improved in the various embodiments of the invention by increasing the overall quality of the traders in the network. For example, traders with poor historical trade success could be periodically removed from the network and replaced with new traders with better results, more sources of information, more expertise, etc. Thus, the quality of information in the network can be improved without increasing the network's size so much as to distort the market.

The best mode of operation contemplated for the invention would be to integrate with an existing trading platform (for example, forex.com) as a value-added service for the existing platform users. The existing platform users would be incorporated into the network of traders in order to participate in the information sharing and opinion collecting processes and benefit from the improved predictions regarding the favorability of proposed transactions. Integrating with an existing trading platform is beneficial because of the network of traders will have a large initial size, users/traders will not have to switch to a new trading platform, and the historical trade data stored by the trading platform can be used to quickly determine useful trade success values for the platform users and apply them immediately to weight opinions collected about proposed transactions.

The embodiments of this disclosure relate to a new approach to enhance trading performance by pooling together knowledge of individual traders in order to mitigate risk. Currently, information about traders' anticipation, behavior, trading patterns and performance is available to incumbent FX retail brokers, who source this information from their trading systems and extract scarce data. Such information can be exploited by FX brokers in order to enhance the trading performance of their customers. Several market participants, such as curensee.com and tradency.com, enable their customers to mirror the trading activities of other well performing traders. However, embodiments of this disclosure overcome the inherent weakness of this approach, which relies on an individual trader's knowledge and judgment by sourcing, pooling and ranking the success of individual traders.

Certain embodiments of the disclosure pertain to the use of crowd sourcing to describe information and correlate this information to the FX market. Examples of the use of crowd sourcing include the SOFNN or Self-Organizing Fuzzy Neural Network. SOFNN is a mathematical model to decode nonlinear time series data of a crowd to describe the characteristics of information and to help to correlate this information for example with market (Bollen et al). Another example is the use of social networking tools such as Twitter. Indiana University and the University of Manchester have demonstrated 87.6% accuracy in prediction of the Dow-Jones Industrial Average via emotional words on Twitter via a SOFNN model (Jordan, 2010). In the invention this information can be used to determine an opinion on whether a transaction would result in financial gain or loss.

Certain embodiments of the disclosure concern a network of traders subscribed to a system for the acquisition, pooling together and dissemination of FX based information. In such embodiments, the network may be a network of users connected via a computer network, a social network and the like. In such embodiments, the network may be a subscription service which is able to identify subscribers, such as FX or commodity traders. In such embodiments, the network may record the successes and failures of each subscriber or subscriber based financial gain or loss of each trade a subscriber or by a recommendation or approval of a trade which would result in a financial gain or loss.

Certain embodiments of the present disclosure relate to the use of crowd sourcing and knowledge pooling to generate a model known as Share and Trade. Share and Trade can comprise attention concentration, information sharing, ranking, social networking or a combination thereof.

### Embodiment

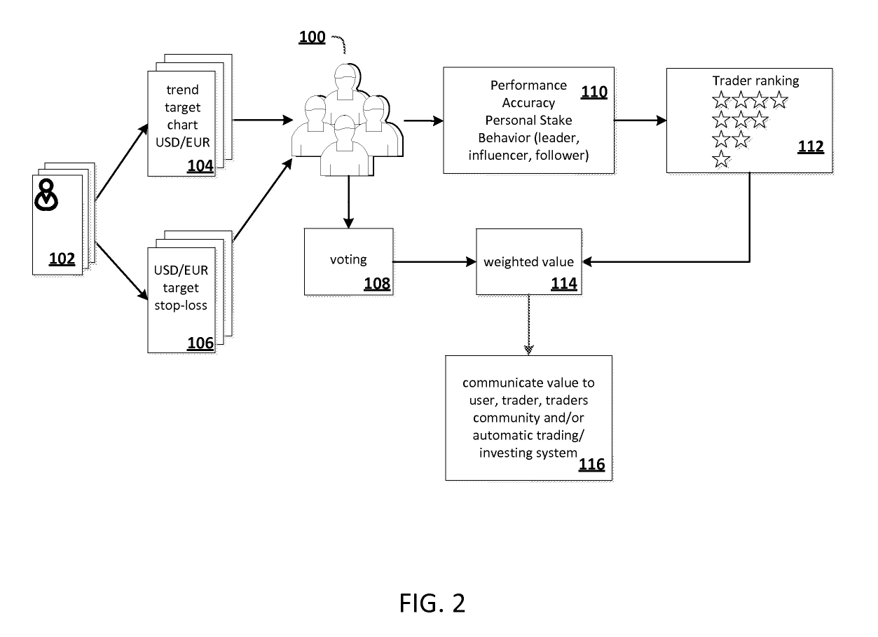

FIG. 2 illustrates an exemplary embodiment of the invention. For example, each trader in trader network 100 may be represented by a user profile 102. Traders receive trade information 104 regarding a proposed transaction, which may be presented to the trader in a trade alert 106. Trade alert 106 may be presented by e-mail, message board, system-integrated application, pop-up, and the like. Trade information 104 and trade alert 106 may be tailored to the particular trader based on the information in his or her user profile 102. Trade information 104 may include numerous trading factors relevant to the transaction, for example, the exact time, currency pair, all currency pair movements after exact time relating to trading timeframe or trading habit, the order or trading type (e.g., market, limit, stop, one cancels other (OCO), if then, if then OCO, trailing stop), amount, quantity, or lot size (e.g., mini, standard, maxi), short vs. long, buy vs. sell, order or trading rate (e.g., previous, current, anticipated, entry, cancellation, or exit triggering rate), value at risk (V@R), given in percentage terms, monetary terms, tiers, or other form of risk-revenue explanations, trading habits (e.g., short/day trading, long/trend trading), trading timeframe (e.g., yearly, monthly, weekly, daily, 4 hours, 2 hours, 1 hour, 30 minutes, 15 minutes, 10 minutes, 5 minutes, 1 minute, or any timeframe in between), trading charts in different timeframes (e.g., yearly, monthly, weekly, daily, 4 hour, 2 hour, 1 hour, 30 minute, 15 minute, 10 minute, 5 minute, 1 minute, or any timeframe in between), wave/candlestick/other form of chart interpretation technique, leverage (e.g., 1:1, 1:10, 1:25, 1:50, 1:100, 1:200, or any in between), limit orders and/or upside/downside targets, stop-loss limits, or any other form of factor relating to trading and/or trade anticipation. Trade information 104 and trade alert 106 may also concern other market-related data besides proposed transactions, for example, a demo account transaction without monetary risks, a proposed chart interpretation, or any sort of idea/information/feedback relating to the aforementioned trading factors. The trader's opinion on whether the trade is likely to result in financial gain or loss can be determined, for example, by voting in step 108. Other possible methods for determining trader opinions include, without limitation, tweeting, podcasting, blogging, or other instant messaging possibility which may be used in SOFNN or other data and time series mathematical models to decode, group, and crunch linear or non-linear expressions. In step 110, traders are evaluated based on performance measures such as, for example, accuracy of previous trade opinions, degree of risk-taking, analysis of prior behavior (leader, influencer, follower), overall trading performance. This evaluation contributes to a trader's success rating, for example, a “star” ranking system 112. The trader's success rating is used to weight the vote in step 114 to determine a weighted value indicating approval or disapproval of engaging in the proposed transaction. The weighted value is then communicated to the user in step 116. In some embodiments, favorable transactions may be executed automatically on behalf of the user, and/or another party, such as another trader and/or a network administrator and/or an investor and/or investment fund.

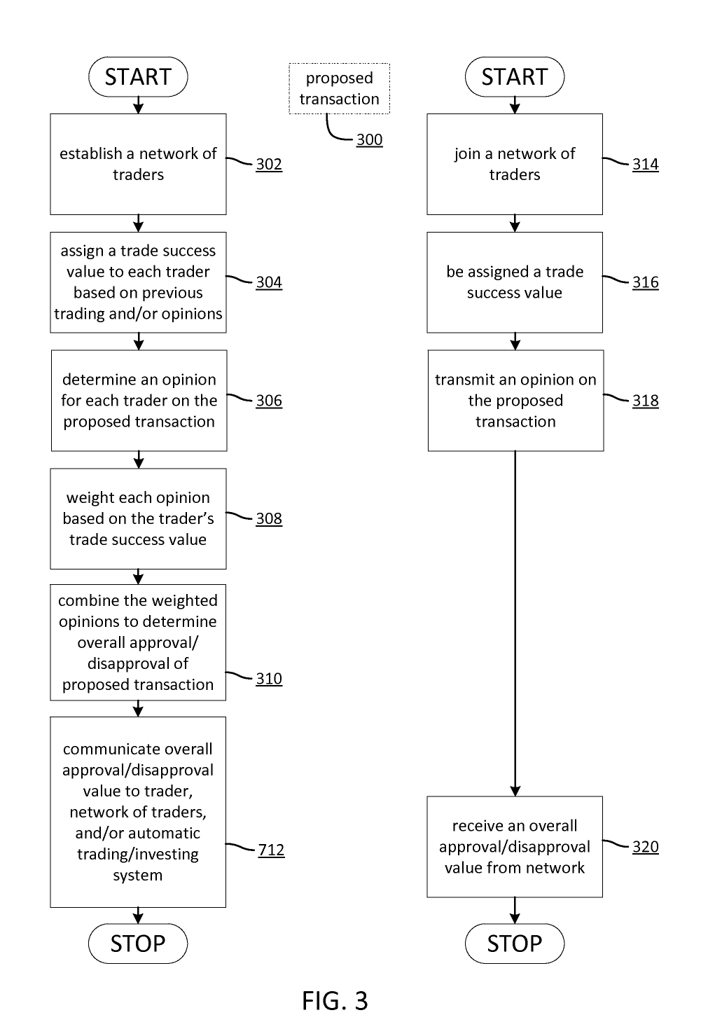

The method of determining whether to engage in a proposed transaction is different, but parallel, from the perspectives of the network and of the traders. In FIG. 3, proposed transaction 300 is evaluated. From the network's perspective, a network of traders is established (e.g. based on current trading platform users) in step 302, and based on historic activity/performance a trade success value is assigned to each trader in step 304. In step 306, each trader's opinion on the proposed transaction 300 is determined. These opinions are weighted in step 308 based on each trader's trade success value, as assigned in step 304. The weighted opinions are combined in step 310 to determine an overall approval/disapproval value for proposed transaction 300, and this value is communicated to the traders in step 312. From the trader's perspective, a trader joins the network of traders in step 314 and is assigned a trade success value in step 316. In step 318, the trader transmits his or her opinion on proposed transaction 300. Once the network has processed the opinions from the network, the trader may receive an overall approval/disapproval value in step 320, indicating whether or not to engage in the proposed transaction 300. All trader's activities (his/her opinion and/or trading before, in parallel or after the proposed transaction) are measured against actual market movements and incorporated to the success value assigned to each trader. Hence the success value is in continuous change based on the traders activities.

Traders' opinions can also be collected on more general questions such as, for example, the general direction of a currency pair over the next few hours, or pattern analysis of a historical chart. This is especially useful when implementing a new system with a small pool of traders and limited data. Past performance and trade behavior can also be evaluated based on information in an existing database by, for example, connecting to an existing trading platform such as forex.com.

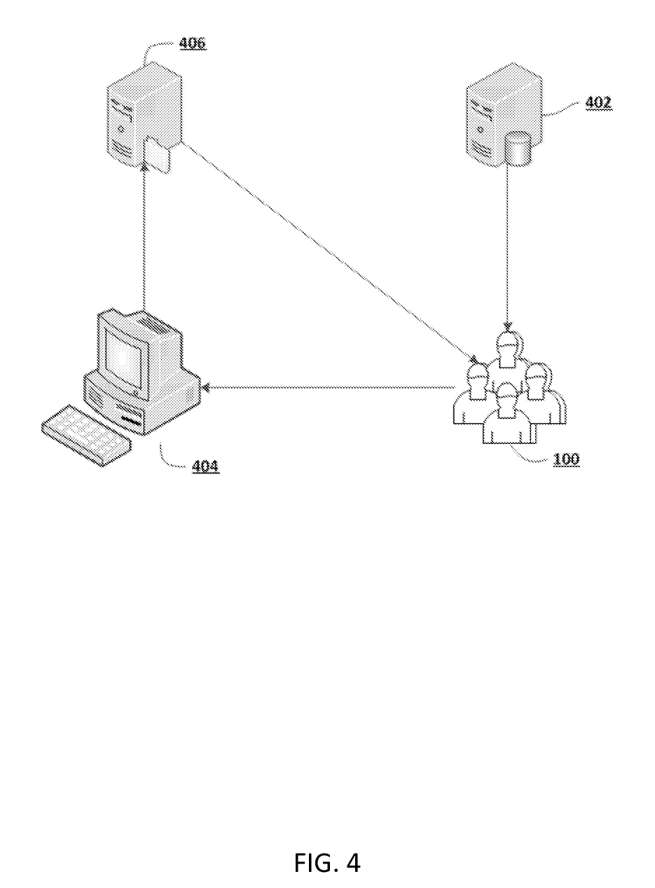

FIG. 4 illustrates one possible embodiment of a system for determining whether to engage in a transaction. A grading system 402 assigns a trade success value to each of the traders in the network of traders 100. An opinion collecting system 404 determines the traders' opinions on, for example, proposed transactions, and weights them based on the corresponding trader's trade success value, assigned by grading system 402. An evaluation system 406 combines these weighted opinions to generate an overall approval/disapproval value and communicates this value to the traders in the network of traders 100.

In other embodiments, some elements of the system may be combined for more efficient operation. For example, the opinion collecting system 404 and evaluation system 406 may be combined to collect and evaluate opinions simultaneously. Elements of the system may be located on a server, on the user's platform, in a distributed network or the like, or some combination thereof.

Elements of the system may also be integrated with preexisting systems, such as a commercial trading platform. For example, while using trading software for a commercial trading platform, a trader may receive a trade alert requesting his or her opinion about a proposed transaction. The trader may respond to the trade alert with an opinion, for example, by voting ‘yes’ or ‘no’ to the proposed transaction, or by rating it on a scale of 1-10, or other various means of opinion collection described herein. An opinion collecting system may receive this response, along with responses from other traders in the network, and weight them according to trader's recent success value. An evaluation system may then combine these weighted opinions to generate an overall approval/disapproval value, e.g., 60% of opinions, as weighted, favor engaging in this transaction, and may/or may not communicate this value to traders in the network. The latter may depend on the established remuneration, charging, motivation and/or contribution system of the traders network and/or trading platform.

In particular embodiments, this value is communicated after a trader's opinion is collected, for instance, once the trader responds to the proposed transaction with a ‘yes’ or ‘no’ opinion, the trader may receive a response indicating the overall approval/disapproval value from the network. The trader may then use this information, for example, to decide whether or not to engage in the proposed transaction. For instance, if the value indicates approval, the trader may engage in the transaction, or, if the value indicates disapproval, the trader may decide not to engage in the transaction, or, for example, may decide to engage in the opposite transaction (e.g., going short instead of going long). If the system is integrated within a commercial trading platform, the trader may be able to engage in the trade using the same software. In other embodiments, the system may engage in these transactions automatically when the value exceeds certain threshold values, for example, when the value is greater than 50% or ½, the system may engage in the proposed transaction. Other threshold values may be used, or adjusted by the trader or network administrator, for example, according to their desired behavior and/or risk.

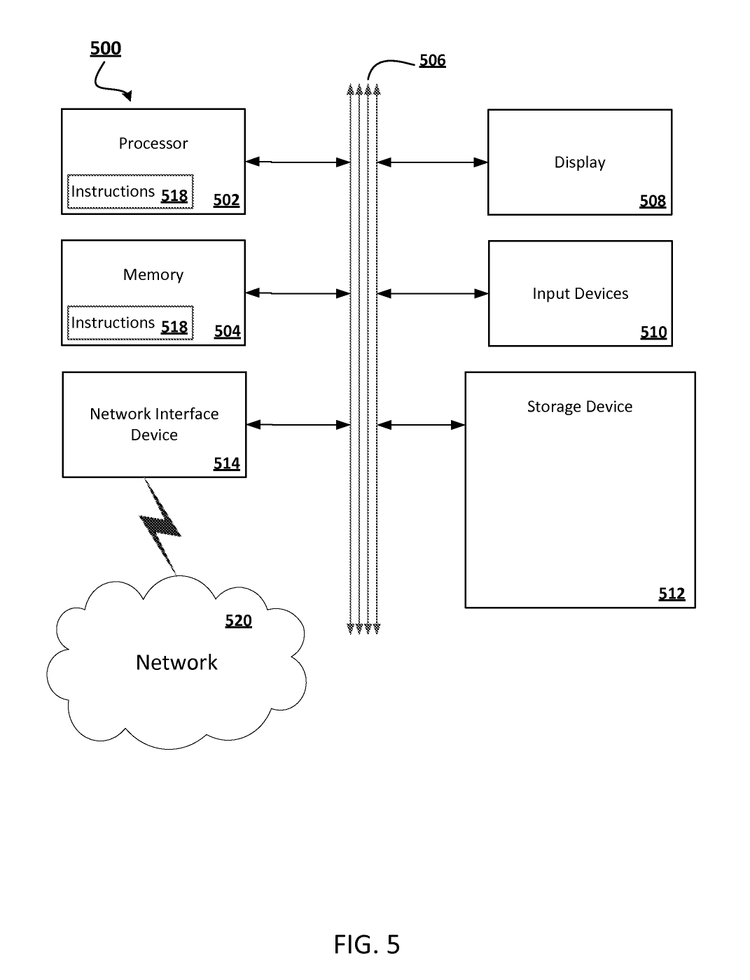

FIG. 5 illustrates schematically an exemplary embodiment of a computer system 500 for executing a set of instructions that, when executed, can cause the computer system to perform the processes described above. The computer system 500 can be connected to other computing devices, for example, using a network. In a network, computer system 500 can function in either a server or client capacity, or as a peer machine in a peer-to-peer/distributed network.

The machine can comprise various types of devices, including a personal computer (PC), a server computer, a desktop computer, a laptop computer, a tablet PC, a network router/bridge, or any device capable of executing instructions that specify actions to be taken by the device. While a single device is illustrated, the phrase “computer system” includes any collection of computing devices that execute a set of instructions (individually or jointly) to perform any of the processes described in the present disclosure.

Computer system 500 can include a processor 502 and a memory 504 which communicate together via a bus 506. Computer system 500 can also include a display 508, such as a video monitor. Computer system 500 can include, for example, input devices 510 (such as a mouse and/or keyboard), a storage device 512 (such as a disk drive or optical drive), and a network interface device 514.

Storage device 512 can include a computer-readable non-transitory storage medium 516 which stores one or more sets of instructions 518 operable to implement one or more of the processes described in the present disclosure. Instructions 518 can also be stored within the processor 502 or the memory 504, completely or partially. Computer system 500 can communicate over a network 520, using network interface device 514, and can also send or receive instructions 518 over the network 520. Network 520 may be, for example, a packet switched network using protocols such as TCP/IP, HTTP, etc. Network 520 may also represent any other suitable form of communication between devices, modules, or computer systems, such as USB, PCI, SPI, I2C, or other standards or protocols having the same functions, which may be considered equivalents.

According to one contemplated embodiment, the processes described herein are performed by the computer system 500, in response to the processor 502 executing an arrangement of instructions contained in memory 504.

Such instructions can be read into memory 504 from another computer-readable memory, such as storage device 512. Execution of the arrangement of instructions contained in memory 504 causes the processor 502 to perform the process steps described herein. One or more processors in a multi-processing arrangement may also be employed to execute the instructions contained in memory 504. In alternative embodiments, hard-wired circuitry may be used in place of or in combination with software instructions to implement the various embodiments (for example BI, data mining, data crunching, SOFNN, etc.). Thus, the exemplary embodiments are not limited to any specific combination of hardware circuitry and software.

The computer system 500 also includes a network interface device 514 coupled to bus 506. The network interface device 514 provides a two-way data communication coupling to a network 518. For example, the network interface device 514 may be a digital subscriber line (DSL) card or modem, an integrated services digital network (ISDN) card, a cable modem, a telephone modem, or any other interface device to provide a data communication connection to a corresponding type of communication line. As another example, network interface device 514 may be a local area network (LAN) card (e.g., for Ethernet or an Asynchronous Transfer Model (ATM) network) to provide a data communication connection to a compatible LAN. Wireless links can also be implemented. In any such implementation, network interface device 514 sends and receives electrical, electromagnetic, or optical signals that carry digital data streams representing various types of information. Further, the network interface device 514 can include peripheral interface devices, such as a Universal Serial Bus (USB) interface, a PCMCIA (Personal Computer Memory Card International Association) interface, etc. Although a single network interface device 514 is depicted in FIG. 5, multiple network interface devices can also be employed.

The network interface device 514 typically provides data communication through one or more networks to other data devices. For example, the network interface device 514 may provide a connection through network 518, which may be a local network (LAN), a wide area network (WAN), or the global packet data communication network commonly referred to as the “Internet”), or to data equipment operated by a service provider. The network 518 uses electrical, electromagnetic, or optical signals to convey information and instructions.

The computer system 500 can send messages and receive data, including program code, through the network 518, the network interface card 514, and the bus 506. In the Internet example, a server (not shown) might transmit requested code belonging to an application program for implementing an exemplary embodiment through the network 518, and the network interface device 514. The processor 502 may execute the transmitted code while being received and/or store the code in the storage device 512, or other non-volatile or volatile storage for later execution. In this manner, the computer system 500 may obtain application code in the form of a carrier wave.

Many physical implementations of computer system 500 are possible, including software, hardware (e.g., general processor, Digital Signal Processing (DSP) chip, an Application Specific Integrated Circuit (ASIC), Field Programmable Gate Arrays (FPGAs), etc.), firmware, or a combination thereof, constructed to implement the methods and processes described herein. Computer system 500 may also be embedded in a variety of electronic/computer systems, or may coordinate with one or more modules or devices in other electronic/computer systems to implement the methods and processes described herein. The methods and processes described herein can also be stored as software on a computer-readable non-transitory storage medium and run on a computer processor.

The term “computer-readable non-transitory storage medium” as used herein refers to any medium that participates in providing instructions to the processor 502 for execution. Such a medium may take many forms, including but not limited to non-volatile media and volatile media. Non-volatile media include, for example, optical or magnetic disks, such as the storage device 512. Volatile media include dynamic memory, such as memory 504. Common forms of computer-readable non-transitory storage media include, for example, a floppy disk, a flexible disk, hard disk, magnetic tape, any other magnetic medium, a CD-ROM, CD-RW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, or any other medium from which a computer can read.

Various forms of computer-readable non-transitory storage media may be involved in providing instructions to a processor for execution. For example, the instructions for carrying out various embodiments may initially be borne on a magnetic disk of a remote computer. In such a scenario, the remote computer loads the instructions into main memory and sends the instructions over a telephone line using a modem. A modem of the local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on a storage device either before or after execution by the processor.

Attention Concentration

The current retail FX market participants fail to crowd source because they do not concentrate their customers'/traders'/users' attention towards certain specific trading actions. In certain embodiments of the disclosure, attention concentration can be implemented to turn crowd attention to specific trade and/or trade related terms (currency pair, technical data, buy/sell, limit, stop-loss, time, scale, leverage, risk etc). The attention concentration is important in order to generate crowd attention on one specific transaction or transaction related term out of many other options. Crowd attention is a basis for accessing crowd sourcing. In particular embodiments, crowd sourcing can be accomplished via one or more of the following: 1) trade blogging, podcasting, instant messaging, where concrete trade related data is sent out for others to respond with their opinion about the concrete data; 2) trade ideas, hints or alerts sent over by e-mail, message board, system-integrated application, pop-up etc.; 3) real trades executed by selected person or randomly chosen customers/members/traders/investors. In embodiments of the disclosure wherein attention concentration is contemplated, the initial attention concentration may be generated by a user of the trading network or an administrator of the trading network.

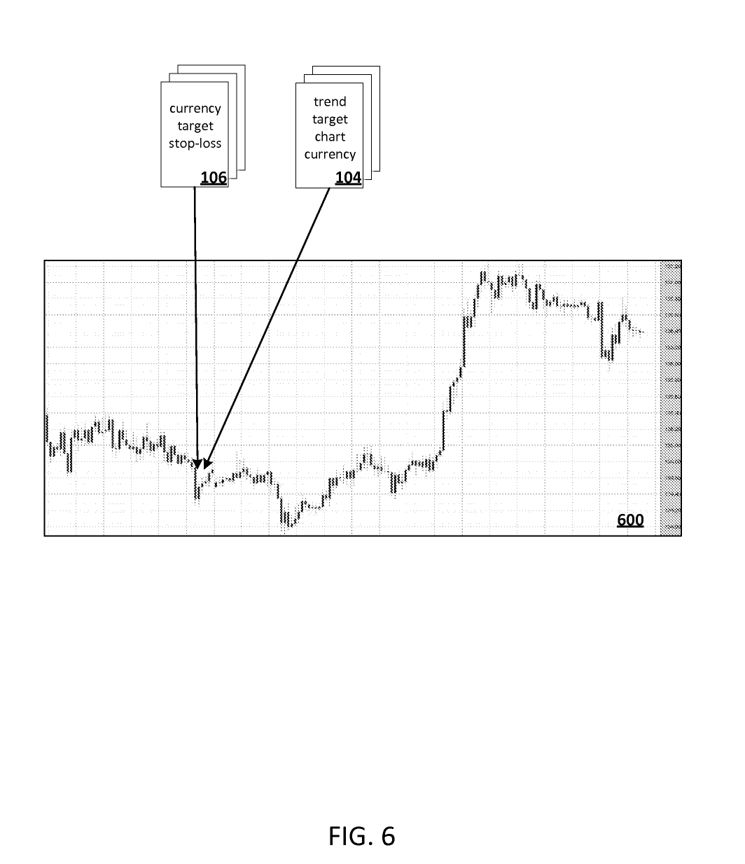

See, for example, FIG. 6, which illustrates attention concentration based on the market chart 600. Trade information 104 is derived from a specific proposed transaction, determined, for example, by a trade alert 106 initiated by a user, trader, network administrator, or the like. In this way the traders' attention is focused on a specific proposed transaction, increasing the value of the crowd sourced opinion collecting.

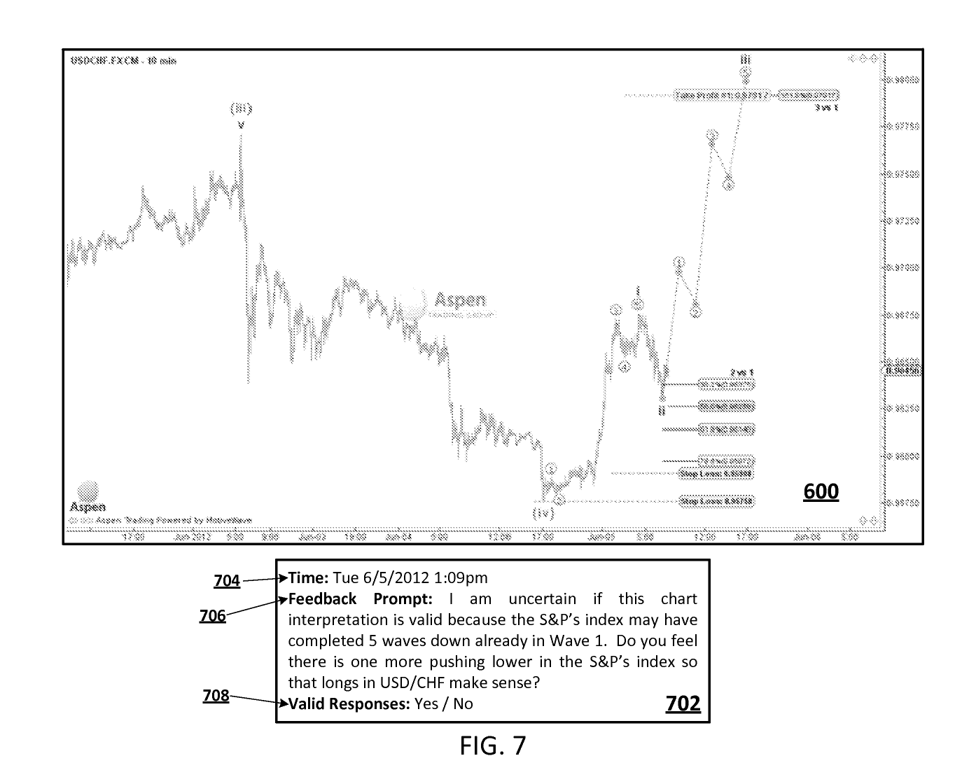

Attention may also be concentrated on ancillary information, rather than a specific proposed transaction. For example, a trader may be presented with a chart of a particular currency pair over some period of time and asked to interpret it in some way: e.g., predict its movement over the next four hours, identify and recognize patterns within the chart, etc. See, for example, FIG. 7 which illustrates a market chart 600, presented along with chart information 702, for opinion collection. Chart information 702 may include, for example, the time 704 that the alert or query was created, a feedback prompt 706 with a question about the chart's interpretation, and a set of valid responses 708, for example, Yes/No, Agree/Disagree, Long/Short, Up/Down, Valid/Invalid, 1 Hr/2 Hr/4 Hr, etc. Any set of valid responses 708 could be used, in order to enable the recipient trader to deliver an opinion in response to the feedback prompt 706.

Attention may also be concentrated by external events; for example, a speech by an important government figure, or an economic summit. In these situations, opinions may be collected while attention is concentrated, for example, by analyzing Twitter moods via SOFNN analysis, trade blogging, instant messaging within the trading network, etc.

Information Sharing

Certain embodiments of the present disclosure concern information sharing over a network such as a subscription based computer network of subscribers who are engaged in FX or commodities trading. In such embodiments, the Share and Trade system may collect information from crowds (crowd sources) through information sharing and opinion collecting, as for example by rating application possibility where one can show his/her expressions of trading hint/alert/pop-up through next possibilities such as: 1) binomial voting possibilities, e.g. like/don't like; 2) number format to express grade of expression, e.g. a scale of 1 to 10; and/or 3) other expressions (face images) or data.

In certain embodiments, information sharing may be collected by tweeting, podcasting, blogging or other instant messaging possibility which is used in SOFNN or other data and time series mathematical models to decode, group and crunch linear or non-linear expressions.

In other embodiments, information sharing may be accomplished via the use of charts, figures, tables or statistical/technical data sharing, wherein expressions/beliefs/indications are collected regarding market data, trading hints, technical data/charts, pattern analysis, etc.

The above explained technology of information sharing and rating could be explained also through the terms of crowd sourcing, knowledge pooling and/or herd behavior or herd activities mirroring/monitoring/reflecting. The information containing in the dataset is usually random and nonlinear. Voting possibilities enable synthesis of this information towards linear or binominal statistical evidence of herd/crowd beliefs (for example, 60% of traders think this is a good trade, see Table 1 below).

User behavior can be identified from past opinion collecting and/or voting. For example, if a user tends to agree with well-known/successful traders, or tends to agree with the majority of the crowd (e.g., 80% of traders have voted in favor of a transaction, user votes in favor), even when the well-known/successful traders or the majority of the crowd are wrong about the predicted market movement, that user may be identified as a follower. Conversely, a user may tend to be right when he or she goes against the majority opinion, and thus may be identified as a leader. Or, for example, if a user has many followers who track his or her opinions, that user may be identified as an influencer. User behaviors can then be used to evaluate the credibility of a user's opinion on a proposed trade.

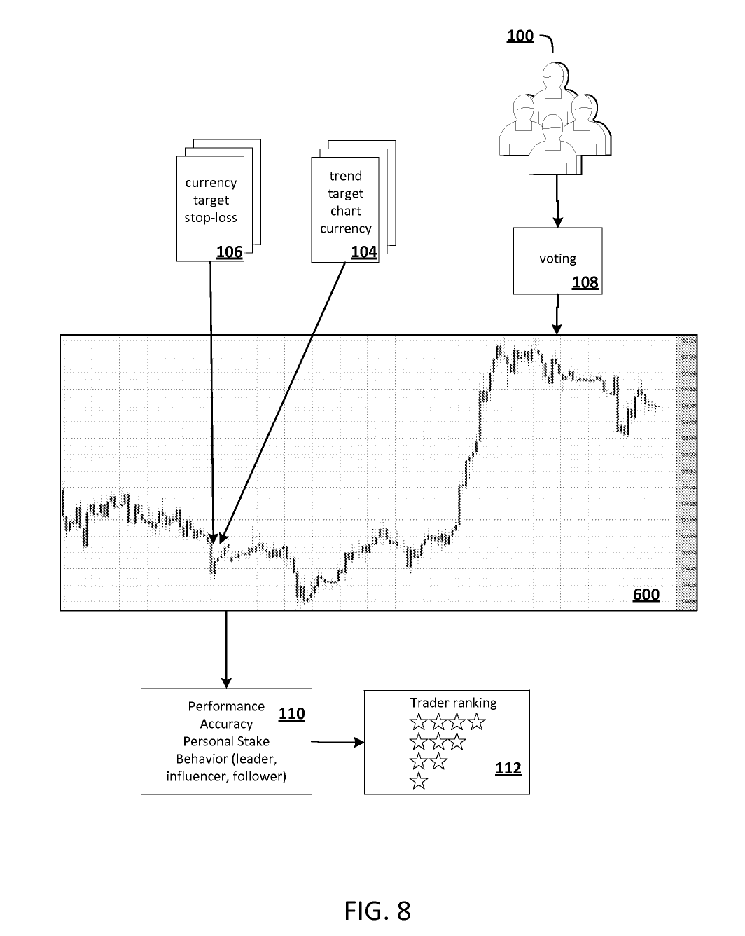

See, for example, FIG. 8, which illustrates this information sharing with respect to a market chart 600. Trade information 104 is derived from a specific proposed transaction, determined, for example, by a trade alert 106 initiated by a user, trader, network administrator, or the like. The opinions of traders from trader network 100, regarding the proposed transaction, are determined, for example, by collecting votes in step 108. The traders may be ranked or graded in step 110 based on prior trading, voting, idea sharing, and the like, including correlation with real market movements, for example, with FX market 600. The ranking or grading may be, for example, a “star”-based ranking system, as in step 112, or any other useful ranking or grading system to measure the trader's success.

Ranking, Weighting and/or Grading

In certain embodiments, the information sharing of an individual user or subscriber to a network may be ranked or graded based on the subscriber's previous performance based on the subscriber's trading, voting, trade activity, idea sharing, and the like, including correlation with real market movements. In such embodiments wherein a network of subscribers is employed, a Share and Trade system holds a user profile, where all possible user activities are tracked. This information may be correlated to real market information in order to synthesize the subscriber's ability to predict market movements. In such embodiments, the network will use such historical data to assign each subscriber a ranking. The ranking of each subscriber can be factored in to the total opinions for each proposed trade in order to generate a weighted approval or disapproval of the proposed trade. Table 1 illustrates a ranked system where trader opinions are determined from votes.

TABLE 1
Ranked Voting

| | Vote | Trader | Vote | |
|---|---|---|---|---|
| Trader No. | (Y/N) | Ranking | Quality | |
| 1 | Y | 1/5 | 1 Y | Totals Before Weighting |
| 2 | Y | 2/5 | 2 Y | 10 opinions (total) |
| 3 | N | 4/5 | 4 N | Yes: 6/10 (60%) |
| 4 | Y | 2/5 | 2 Y | No: 4/10 (40%) |
| 5 | N | 3/5 | 3 N | |
| 6 | Y | 1/5 | 1 Y | Totals After Weighting |
| 7 | Y | 1/5 | 1 Y | 26 weighted opinions (total) |
| 8 | N | 5/5 | 5 N | Yes: 9/26 (35%) |
| 9 | Y | 2/5 | 2 Y | No: 17/26 (65%) |
| 10 | N | 5/5 | 5 N | |

In short: although 60% of the traders think it is a good trade, the performance weighted result shows 65% tilted result towards NO. In this illustration, the opinions are derived from yes/no voting. The same opinions could be derived from tweeting/blogging/podcasting/instant messaging/chart sharing/data sharing/other forms of expression using SOFNN or other type of linear and/or nonlinear data decoding techniques. The Share and Trade system may collect the needed dataset for data decoding.

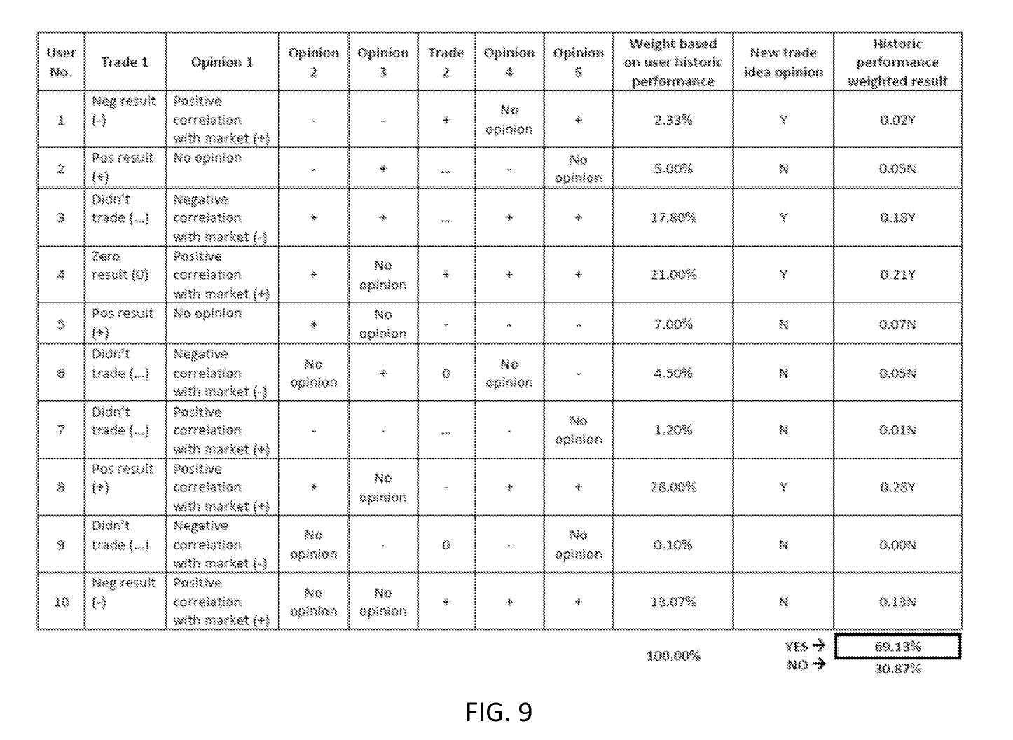

Other examples of the user ranking and weighting system are illustrated in FIG. 9. In embodiments of the disclosure, Share and Trade may utilize this ranking and weighting information to analyze, share and place trades. In certain embodiments, Share and Trade weights the potential new FX trade or commodity trade through previous trading results as illustrated in FIG. 9. In this example, opinions are weighted based on the correlation of past opinions with actual market movement. Users whose opinions have a strong correlation with the market are weighted more heavily. For example, of the five opinions collected, four of user 8's opinions had a positive correlation with the market movement, so user 8's opinion on the new trade represents 28% of the combined opinion, even though user 8 represents only 10% of the total pool of users. Conversely, user 9 only participated in three opinions, all of which had a negative correlation with the market movement, and user 9 only engaged in one of the two trades. As a result, user 9's opinion represents only 0.10% of the combined opinion, although user 9 represents 10% of the total pool of users. So, even though most users think the trade is unfavorable, the users who think it is favorable are historically successful users with higher weights, and the total result is 69.13% in favor of the trade.

In the various embodiments of the invention, many other elements can be used for evaluating the trade success value of each trader. For example, a trader who actually engages in the transactions that he or she rates as favorable—that is, a trader who has a personal stake in his or her opinion—may be more reliable than a trader who is just offering a bare opinion, and can be weighted accordingly. The trader's behavior—for example, whether he or she is a leader, influencer, follower, or the like—can be used to weight the trader's opinion, as well. The trade success value can also be based on the trader's results in answering general questions, as opposed to the market success of past proposed transactions. For example, traders may be asked to evaluate a chart and identify a pattern, or predict the general movement of a currency pair over a specific time period. Traders whose opinions tend to be correct about these kinds of general questions may be weighted more highly when considering their opinions about specific transactions, because they are likely skilled traders with substantial information about the market.

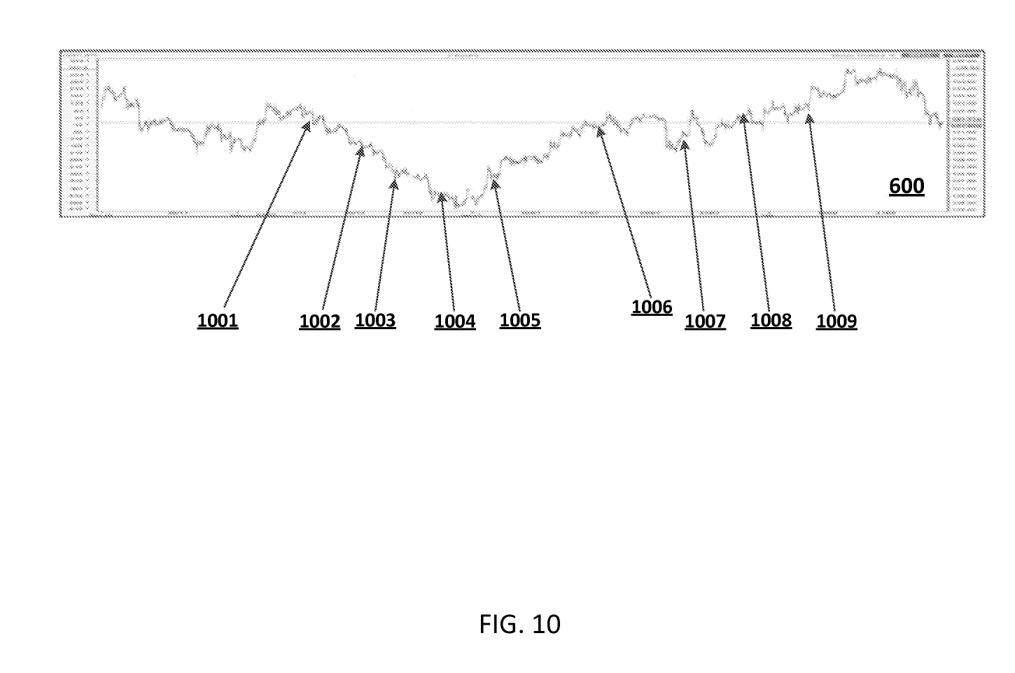

FIG. 10 illustrates an exemplary embodiment of the ranking/weighting aspect of a trading system according to the invention. Market chart 600 illustrates the movement of the market over time, upon which various examples of events tracked by the system are overlaid. At event 1001, the trader 102 does something which is traceable, for example, making a trade (either on a real trading account or a demo account without monetary risks), proposing a trade, proposing a chart interpretation, or any other form of input of an idea, piece of information, or requested feedback. At events 1002-1005, the system tracks after certain intervals the performance of the traceable activity and measures/compares market 600 data/movements with the initial data at the time of event 1001. Event 1006 is an example of the next activity by the trader. Events 1007-1009 are example of subsequent activities by the trader where the system tracks next activity of the trader over time and analyzes them statistically in order to find performance indicators (relations and correlations of traders activities with market data) and integrates the results to the previous results/measures based on the previous activities. The same process/iteration continues with every measurable action by the trader/user/customer of the system.

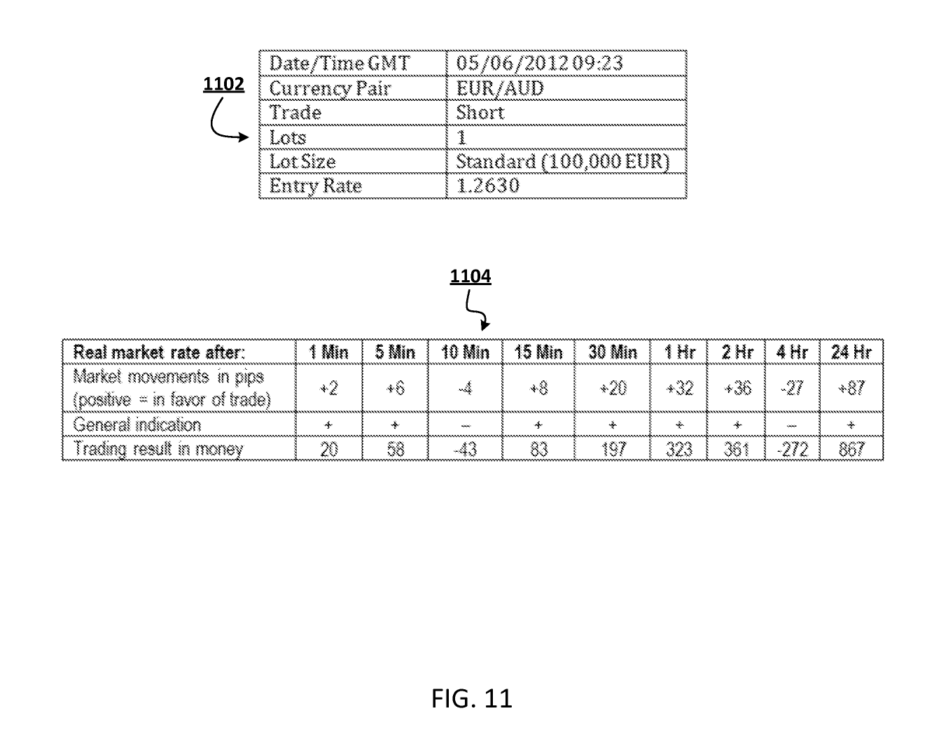

FIG. 11 illustrates an example of the statistical analysis of trade activity and market data used in the various embodiments of the invention. Example trade 1102 depicts some of the elements of a FX market transaction—the time of the order, the currency pair traded, the type of trade, the number and size of lots traded, and the entry rate of the order. Table 1104 depicts the real market results of example trade 1102, expressed in terms of potential gains/losses at various trade durations (e.g., what would the gain/loss be if the position were closed after 1 minute, 5 minutes, 10 minutes, 15 minutes, and so on). As table 1104 illustrates, in general the example trade 1102 works in favor of the trader—most of the timely positions are indicated positive. As the market moves, so change the results accordingly and trading performance may be evaluated from two results. Firstly, anticipating/predicting/analyzing the right market trend/direction, based on which the decision of going short or long will be made. Regarding example trade 1102, the trader has anticipated the market trend/direction correctly as most of the positions are positive. Secondly, exiting at the right time. A trader may be good at anticipating the right market trends, but exits the position too early or too late. For example, even though the trader anticipated the right market trend, table 1104 shows that, for example trade 1102, if the position were closed after 10 minutes, or 4 hours, the trade would be exited with a loss. Hence, timing is important, as well as the overall trade trend assessment.

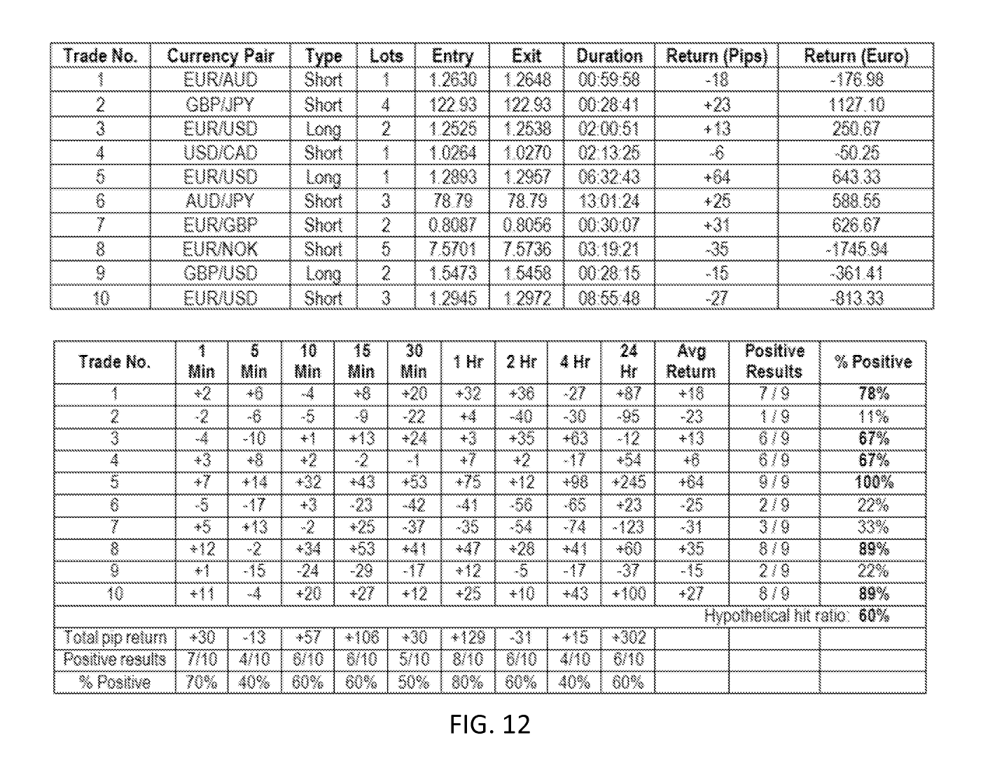

FIG. 12 illustrates an example of how multiple transactions in a trader's history may be analyzed to rank/weight/grade the trader. The upper table in FIG. 12 illustrates a trading history of 10 trades. Here, the trades represent real market trades, but they could also represent demo mode trades (e.g., trades without real money backing), or certain types of opinions (e.g., yes/no on proposed trades, feedback on chart analysis and proposed market trends, etc.). The number of trades is purely exemplary, and the analysis could apply to any number of trades, as low as 1 trade, or as high as 100, 500, 1000, 100,000, or more trades. In this example, the system has tracked a trader's activity for 10 trades. The trader is trading in the EUR currency and using standard lots (100,000 Euros per lot). In this example, the trader has traded in average of 3h51m positions, and the median (most used timeframe) was 2h07m. This indicates that the trader is usually trading short timeframes (e.g., a day trader). The upper table shows that the trader has made 5 positive trades (right anticipation of market and right exit timing) and 5 negative trades (wrong anticipation of market and/or wrong exit timing). The trader's hit ratio (positive trades out of all trades) is 50%, and the total return is 55 pips or [symbol] 88.40. All of these characteristics may be used to weight the trader's opinions in the system, for example, the trader's historical hit ratio, amount of return, the type of trades (day trader), the type of currency most often traded (EUR), etc. For example, a trader with a high historical hit ratio or a high amount of return may be weighted more highly, or a trader may be weighted more highly on opinions that relate to the trader's type of currency or type of trade (day trade, long-term trade) most often traded, or weighted less when it is in a type of currency or type of trade that the trader usually does not trade (implying less experience and a less valuable opinion).

The lower table depicted in FIG. 12 illustrates more examples of analysis of the ten trades in the trader's history, using “what-if” results. In this example, the lower table shows that out of 10 trades, 6 of the trades anticipated the market movements correctly, resulting in a “hypothetical hit ratio” of 60%. This value is derived from counting how many timely positions (e.g., 1 min, 5 min, 10 min, etc.) had positive results out of the total positions (e.g., the first trade had 7 positive outcomes out of 9 possible outcomes). Comparing all the trades, the lower table shows that 6 trades out of 10 had more than 50% positive positions throughout the timeframes. This result shows that, in general, the trader anticipated market movements correctly at a rate of 60% (a good result). The lower table also illustrates the possible hit ratios for various average position times, for example, if the trader had exited all positions after 1 minute, the return would have been 30 units and the hit ratio would have been 70%. Alternatively, if all trades were traded for 1 hour, the return would be much better—129 units, with a hit ratio of 80%.

In the various embodiments of the invention, this statistical evidence brings important insight to the trading performance of individual traders enabling the data to be used by the trader and/or by the trading system (to weight the trader's opinions). The trading system is designed such that relevant statistical and mathematical models are used to derive/synthesize recognizable patterns, correlations, and/or relations, which enable ranking the performance of the traders, and weighting their opinions, using mathematical/statistical modeling of the trader's performance compared to other traders' performance in comparable parameters. For example, if the trader whose trades are analyzed in FIG. 12 responds to “Proposed Trade: Short EUR/USD with 1 hour exit time according to attached chart interpretation”, the system would know that this trader's feedback is in general 60% correct (market anticipation) and that this trader is 80% correct on transactions with 1 Hour timing (exit time). Gathering this information from many traders in the network would enable the network to build statistical evidence/information about traders and rank them according to certain parameters, e.g., general market anticipation (hypothetical hit ratio), EUR/USD movements anticipation (EUR/USD hit ratio), exit timing anticipation (real hit ratio), 1 Hour anticipation (1 Hour timing hit ratio), etc. These performance factors enable the system to weight the traders' opinions according to their performance (and thus, the relative value of their opinions).

The system can also track multiple traders' activities to find useful correlations between their behaviors. For example, correlations may show whether one trader is trading together with some of the other traders (e.g., having the same type of trades on at the same time), following some other traders (e.g., showing followers position and not usually making own decisions before other traders have made decisions), being a leader (e.g., responding quickly and decisively, being followed by some or many of the other traders), being in opposition most of the time (e.g., to a particular trader's anticipation or to the majority anticipation of the community), etc. This information is used in the various embodiments of the invention to determine the behavior characteristics of traders in the network, which can be used to weight the trader's opinions. The information can also be used to find out which people and/or groups within the crowd/network of traders have independent views/market anticipations, which may be based on a particular kind of analysis or a particular source of knowledge/information, and enables the system to collect specific opinions from those who are doing this sort of analysis or have this sort of knowledge/information, as opposed to those who just follow someone or follow the crowd. As a result, the collected opinions are more valuable and useful, and better at predicting market movements and evaluating transactions, because they reflect better analysis and better information.

In certain embodiments of the invention, the system may include a competitive environment allowing traders to see their own performance in relation to others. This competitive environment allows for the possibility of remunerating the best-ranked traders. This encourages participation and helps attract new traders to the network, expanding the pool of knowledge and improving performance.

Impersonalized Social Networks

Collaborative business models are often community based, uniting people with common interests and purpose. The higher the membership, the more data there is produced and the more reliable the data is on statistical/mathematical grounds. However in embodiments of the disclosure, the Share and Trade network is anonymous to eliminate successful users from forming followers and thus the generation of a herd mentality. In such markets, where it is easy for participants to communicate with one another, leaders are followed, resulting in herd behavior (Anderson 2010). For example, if a known and well-performing user is posting a trade alert, users will tend to align their opinions with the well-performing user, despite their own analysis of a potential FX or commodity trade. Such a result does not enable adequate performance tracking and ranking. This, in certain embodiments of the disclosure related to whether a commodity or FX trade should be executed, the opinions, and trader rankings are kept anonymous.

While the invention has been described in connection with a number of embodiments and implementations, it should be understood that the detailed description and the specific examples, while indicating specific embodiments of the disclosure, are given by way of illustration only, since various changes and modifications within the spirit and scope of the disclosure will become apparent to those skilled in the art from this detailed description.

### REFERENCES

Aite Group. (2010) “High Frequency Trading in FX: Open for Business”, [http://www.aitegroup.com/Reports/ReportDetail.aspx?recordItemID=660, (accessed Mar. 14, 2011)]
Anderson, C (2010) “Free. How today's smartest businesses profit by giving something for nothing”. London: Random House Business Books
Bank of International Settlements (BIS). (2010), “Triennial Central Bank Survey. Report on global foreign exchange market activity in 2010”. Monetary and Economic Department, [www.bis.org/publ/rpfxf10t.pdf, (accessed Jan. 21, 2011)]
Bollen, J., Mao H. and Zeng X. (2010) “Twitter mood predicts the stock market”. School of Informatics and Computing, Indiana University—Bloomington; School of Computer Science, The University of Manchester. [http://arxiv.org/PS_cache/arxiv/pdf/1010/1010.3003v1.pdf, (accessed Jul. 2, 2011)]
Federal Reserve Bank of New York (FRBNY). (2010), “The Foreign Exchange and Interest Rate Derivatives Markets: Turnover in the United States”. April 2010.
FXCM Inc. (2010) “FORM S-1-Sep. 3, 2010”. [http://www.faqs.org/sec-filings/100903/FXCM-Inc_S-1/#ixzz1Ct0dR1qc, accessed Apr. 2, 2011)]
GAIN Capital Holdings Inc. (2009) “FORM S-1/A—Nov. 24, 2009”. [http://www.faqs.org/sec-filings/091125/GAIN-Capital-Holdings-Inc_S-1.A/#109#ixzz1CqYRnBVd, accessed Mar. 2, 2011)]
Howe, J. (2010) “The Rise of Crowdsourcing”. [http://www.wired.com/wired/archive/14.06/crowds_pr.html, (accessed Jul. 2, 2011)]
InvestorDictionary.com, [http://www.investordictionary.com/definition/zero-sum, (accessed Jan. 2, 2011)]

What is claimed is:

1. A system for evaluating a transaction, the system comprising:
a network of traders;
a grading/weighting system for assigning a trade success value to each of the traders;
an opinion collecting system for determining an opinion for each trader on whether engaging in a transaction would result in financial gain or loss, wherein each opinion is a weighted opinion based on the trade success value of the trader;
whereby the weighted opinions are combined to generate a value indicating approval or disapproval of engaging in the transaction.

2. The system of claim 1, further comprising a communication system for communicating the value to one or more traders in the network of traders.

3. The system of claim 1, wherein the value is a numeric value.

4. The system of claim 2, wherein a value greater than 50% or ½ indicates that the transaction is favorable.

5. The system of claim 3, wherein the system is further adapted to automatically engage in favorable transactions for one or more of the following: subscribers, traders, network administrators, investors, investment vehicles, investment funds.

6. The system of claim 1, wherein the trade success value is assigned based on the trader's previous success in predicting a change in value in one or more transactions.

7. The system of claim 1, wherein the trade success value is assigned based on one or more of the following:
the trader's previous success in predicting a change in value in one or more transactions;
the trader's previous success in predicting movement of a market over a period of time;
the trader's previous success in identifying one or more patterns in one or more charts;
the trader's financial stake in one or more transactions;
whether the trader is a follower, leader, or influencer;

8. The system of claim 1, wherein the opinions are anonymous.

9. The system of claim 1, wherein the opinion comprises a vote/response from the corresponding trader.

10. The system of claim 1, wherein the opinion is either a yes or a no or any other measurable form.

11. The system of claim 1, wherein the network is a subscription service.

12. The system of claim 11, wherein the traders are subscribers to the network.

13. The system of claim 1, wherein the network is a computer network.

14. The system of claim 1, wherein the opinion collecting system is further operable to receive proposed transactions from one or more of: a subscriber, a trader, a network administrator.

15. The system of claim 14, wherein the proposed transaction is communicated to traders using the network via one or more of: computer mediated social networking, telephone, email, text message, facsimile, mail, a website.

16. A computer-readable non-transitory storage medium, having stored therein a plurality of instructions executable by a computer, said plurality of instructions comprising code sections for performing the steps of:
establishing a network of traders;
assigning a trade success value to each of the traders;
determining an opinion for each trader on whether engaging in a transaction would result in financial gain or loss, wherein each opinion is a weighted opinion based on the trade success value of the trader;
combining each weighted opinion to generate a value, wherein the value indicates approval or disapproval of engaging in the transaction.

17. A computer-readable non-transitory storage medium, having stored therein a plurality of instructions executable by a computer, said plurality of instructions comprising code sections for performing the steps of:
joining a network of traders, wherein each trader is assigned a trade success value;
transmitting a trader's opinion on whether engaging in a transaction would result in financial gain or loss, wherein the opinion is a weighted opinion based on the trade success value of the trader;
receiving a value indicating approval or disapproval of engaging in the transaction, wherein the value is generated by combining the weighted opinion with one or more weighted opinions corresponding to one or more other traders in the network.

18. A method for determining whether to engage in a transaction, the method comprising:
establishing a network of traders;
assigning a trade success value to each of the traders;
determining an opinion for each trader on whether engaging in a transaction would result in financial gain or loss, wherein each opinion is a weighted opinion based on the trade success value of the trader;
combining each weighted opinion to generate a value, wherein the value indicates approval or disapproval of engaging in the transaction.

19. A method for determining whether to engage in a transaction, the method comprising:
establishing a network of traders;
assigning a trade success value to each of the traders;
determining an opinion for each trader on whether engaging in a transaction would result in financial gain or loss, wherein each opinion is a weighted opinion based on the trade success value of the trader;
combining each weighted opinion to generate a value, wherein the value indicates approval or disapproval of engaging in the transaction;
communicating the value to one or more traders.

20. A method for determining whether to engage in a transaction, the method comprising:
joining a network of traders, wherein each trader is assigned a trade success value;
transmitting a trader's opinion on whether engaging in a transaction would result in financial gain or loss, wherein the opinion is a weighted opinion based on the trade success value of the trader;
receiving a value indicating approval or disapproval of engaging in the transaction, wherein the value is generated by combining the weighted opinion with one or more weighted opinions corresponding to one or more other traders in the network.
